(19) United States
(12) Patent Application Publication
(10) Pub. No.: US 2024/0258578 A1
(43) Pub. Date: Aug. 1, 2024

(54) Power Storage Cell

(71) Applicant: TOYOTA JIDOSHA KABUSHIKI KAISHA, Toyota-shi Aichi-ken (JP)

(72) Inventors: Takeru HARA, Toyota-shi Aichi-ken (JP); Seigo Fujishima, Miyoshi-shi Aichi-ken (JP); Atsushi Sugihara, Toyota-shi Aichi-ken (JP); Jun Izumi, Toyota-shi Aichi-ken (JP); Tsuyoshi Kaneko, Nisshin-shi Aichi-ken (JP)

(73) Assignee: TOYOTA JIDOSHA KABUSHIKI KAISHA, Toyota-shi Aichi-ken (JP)

(21) Appl. No.: 18/420,395

(22) Filed: Jan. 23, 2024

(30) Foreign Application Priority Data
Jan. 26, 2023 (JP) 2023-010268

(51) Int. Cl. H01M 10/0587; H01M 50/103; H01M 50/15

(52) U.S. Cl. CPC H01M 10/0587; H01M 50/103; H01M 50/15

(57) ABSTRACT

A power storage cell includes a cell case, a wound electrode assembly, and an electrolyte solution. The cell case houses the wound electrode assembly and the electrolyte solution. The wound electrode assembly includes a positive electrode sheet, a separator sheet, and a negative electrode sheet. In a winding axis direction, the wound electrode assembly has a first end portion and a second end portion. The first end portion faces a top wall. The second end portion is located opposite to the first end portion. At both the first end portion and the second end portion, the separator sheet extends outward with respect to the negative electrode sheet. At the first end portion, the separator sheet has a first protruding length. At the second end portion, the separator sheet has a second protruding length. The first protruding length is longer than the second protruding length.

### CROSS REFERENCE TO RELATED APPLICATIONS

This nonprovisional application is based on Japanese Patent Application No. 2023-010268 filed on Jan. 26, 2023 with the Japan Patent Office, the entire contents of which are hereby incorporated by reference.

### BACKGROUND

### Field

The present disclosure relates to a power storage cell.

### Description of the Background Art

Japanese Patent Application Laid-Open No. 2016-207516 discloses a wound electrode assembly housed in a longitudinal orientation in a case main body.

### SUMMARY

A power storage cell including a wound electrode assembly can be roughly classified into, for example, a “longitudinal type” and a “lateral type”. In the longitudinal type, the wound electrode assembly is housed in a case main body such that the opening surface of the case main body and the winding axis direction of the wound electrode assembly are orthogonal to each other. The “winding axis direction” represents a direction in which the winding axis extends. In the lateral type, the wound electrode assembly is housed in the case main body such that the opening surface of the case main body and the winding axis direction of the wound electrode assembly are parallel to each other. The wound electrode assembly is impregnated with an electrolyte solution.

It is an object of the present disclosure to reduce an imbalance in distribution of an electrolyte solution in a longitudinal type power storage cell.

Hereinafter, the technical configurations, functions and effects of the present disclosure will be described. However, a mechanism of function in the present specification include presumption. The mechanism of function does not limit the technical scope of the present disclosure.

1. A power storage cell includes a cell case, a wound electrode assembly, and an electrolyte solution. The cell case houses the wound electrode assembly and the electrolyte solution. The wound electrode assembly is impregnated with the electrolyte solution. The cell case includes a top wall, a peripheral wall, and a bottom wall. The top wall faces the bottom wall. The peripheral wall connects the top wall and the bottom wall.

The wound electrode assembly includes a positive electrode sheet, a separator sheet, and a negative electrode sheet. A winding axis direction of the wound electrode assembly is along a direction from the bottom wall toward the top wall.

In the winding axis direction, the wound electrode assembly has a first end portion and a second end portion. The first end portion faces the top wall. The second end portion is located opposite to the first end portion. At both the first end portion and the second end portion, the separator sheet extends outward with respect to the negative electrode sheet. At the first end portion, the separator sheet has a first protruding length. At the second end portion, the separator sheet has a second protruding length. Each of the first protruding length and the second protruding length is a length of the separator sheet protruding from the negative electrode sheet in the winding axis direction. The first protruding length is longer than the second protruding length.

The wound electrode assembly includes the positive electrode sheet, the separator sheet, and the negative electrode sheet. Each sheet is strip-shaped (elongated rectangular shape). Each sheet has a length direction and a width direction. The “length direction” is a direction parallel to the long side of the rectangle. The “width direction” is a direction parallel to the short side of the rectangle. The sheets have widths (sizes in the width direction) different from one another. That is, the width of the separator sheet is the largest, and the width of the positive electrode sheet is the smallest. The negative electrode sheet have an intermediate width between them. In the longitudinal type, the winding axis direction is parallel to the width direction. Hence, the separator sheet protrudes outermost in the winding axis direction. At the upper end portion (first end portion) of the wound electrode assembly, the protruding length (projection allowance) of the separator sheet from the negative electrode sheet is the first protruding length. At the lower end portion (second end portion) of the wound electrode assembly, the protruding length of the separator sheet from the negative electrode sheet is the second protruding length. Conventionally, the first protruding length is equal to the second protruding length.

In the wound electrode assembly, the electrolyte solution tends to be likely to overflow from both the end portions in the winding axis direction. This is because a clearance between the sheets is opened at each of both the end portions. The separator sheet is porous. The separator sheet has pores. The separator sheet can suck up the electrolyte solution by capillary action. When the separator sheet protruding from the lower end portion comes into contact with the electrolyte solution overflowing from the lower end portion (the second end portion), it is expected that the electrolyte solution is sucked up to the separator sheet.

The electrolyte solution overflowing from the upper end portion (first end portion) of the wound electrode assembly flows down to the lower end portion along an outer surface of the wound electrode assembly. At the lower end portion, the electrolyte solution can be sucked up to the separator sheet. However, the speed of sucking up the electrolyte solution is low. When the electrolyte solution overflows more frequently from the upper end portion, the sucking-up of the electrolyte solution becomes insufficient. As a result, it is considered that the distribution of the electrolyte solution may be imbalanced in the wound electrode assembly.

In the present disclosure, the first protruding length (upper end portion side) is longer than the second protruding length (lower end portion side). At the upper end portion, the separator sheet protruding long is expected to block the overflow of the electrolyte solution. Since the electrolyte solution overflows less frequently from the upper end portion, it is expected to reduce the imbalance in the distribution of the electrolyte solution.

2. In the power storage cell according to “1”, a ratio of the first protruding length to the second protruding length may be, for example, 1.5 to 5. This is because the imbalance in the distribution of the electrolyte solution may be reduced.

3. In the power storage cell according to “1” or “2”, a difference between the first protruding length and the second protruding length may be, for example, 1 to 5 mm. This is because the imbalance in the distribution of the electrolyte solution may be reduced.

4. In the power storage cell according to any one of “1” to “3”, the first protruding length may be, for example, 2 to 5 mm. The second protruding length may be, for example, 0.5 to 1.5 mm. This is because the imbalance in the distribution of the electrolyte solution may be reduced.

5. In the power storage cell according to any one of “1” to “4”, the cell case may include, for example, a case main body and a lid. The case main body includes the peripheral wall and the bottom wall. The peripheral wall rises from the bottom wall. The case main body has an opening surface. The opening surface faces the bottom wall. The lid includes the top wall. The lid closes the opening surface.

Hereinafter, an embodiment (hereinafter, simply referred to as “the present embodiment”) of the present disclosure will be described. It should be noted that the present embodiment does not limit the technical scope of the present disclosure. The present embodiment is illustrative in all the respects. The present embodiment is nonrestrictive. The technical scope of the present technology includes any modifications within the scope and meaning equivalent to the terms of the claims. For example, it is initially expected to extract freely configurations from the present embodiment and combine them freely.

The foregoing and other objects, features, and aspects of the present disclosure will become more apparent from the following detailed description of the present disclosure when taken in conjunction with the accompanying drawings.

### BRIEF DESCRIPTION OF THE DRAWINGS

FIG. 1 is a schematic perspective view of a power storage cell according to the present embodiment.

FIG. 2 is an exploded perspective view of the power storage cell according to the present embodiment.

FIG. 3 is a schematic cross-sectional view of the power storage cell according to the present embodiment.

FIG. 4 is a conceptual diagram showing a stacking structure of a wound electrode assembly.

### DESCRIPTION OF THE EMBODIMENTS

In this embodiment, geometric terms (e.g., “parallel”, “vertical”, “orthogonal”, etc.) should not be construed in a strict sense. For example, “parallel” may be somewhat offset from “parallel” in a strict sense. Geometric terms may include, for example, tolerances, errors, etc., in design, operation, manufacturing, etc. The dimensional relationship in each figure may not match the actual dimensional relationship. Dimensional relationships (length, width, thickness, etc.) in each figure may have been changed to assist the reader in understanding. Further, some components may be omitted. In the drawings, the same or corresponding members may be denoted by the same reference numerals.

A numerical range such as “m to n %” includes an upper limit value and a lower limit value unless otherwise specified. That is, “m to n %” indicates a numerical range of “m % or more and n % or less”. Further, “m % or more and n % or less” includes “more than m % and less than n %”. The terms “more than or equal to” and “less than or equal to” are denoted by the equalized inequality “≤”. “More than” and “less than” are denoted by inequality “<” which does not include equality.

### 1. Power Storage Cell

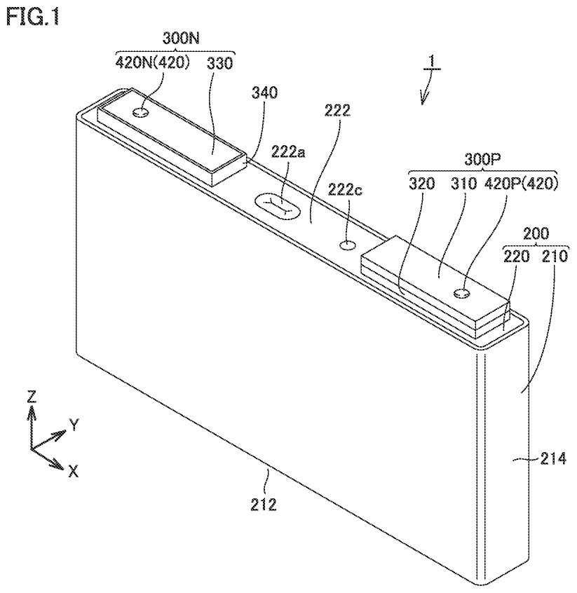

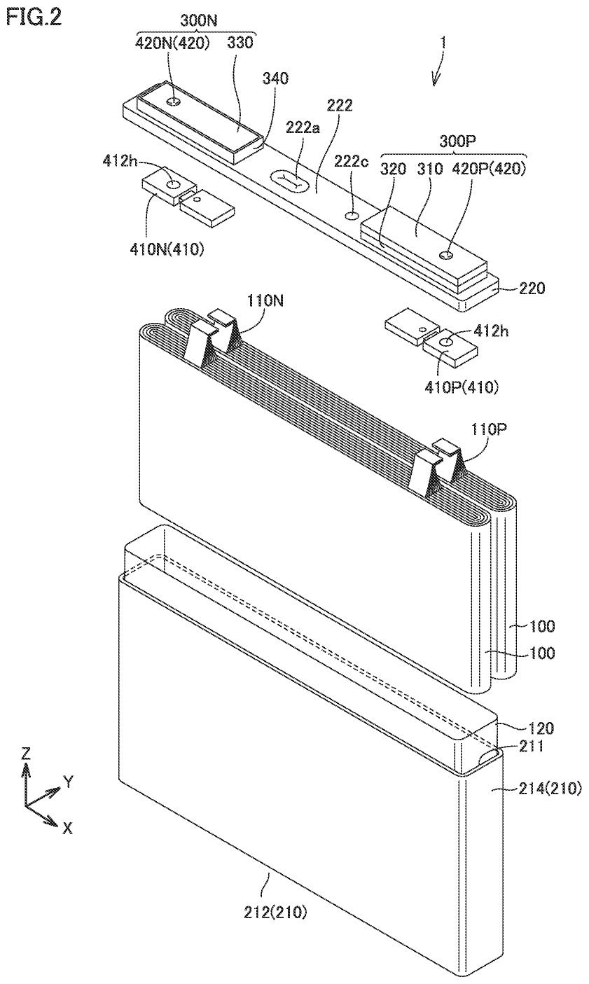

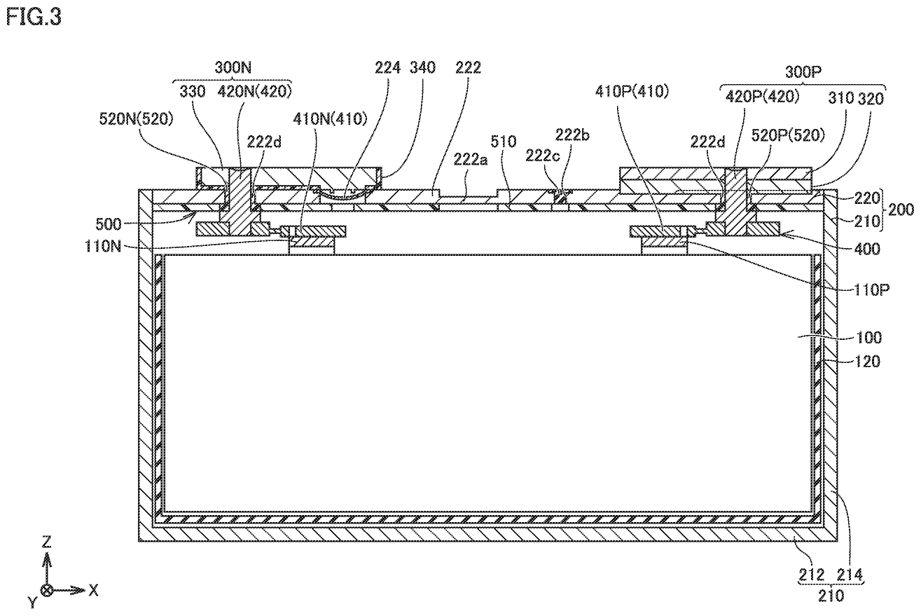

FIG. 1 is a schematic perspective view of a power storage cell according to the present embodiment. FIG. 2 is an exploded perspective view of the power storage cell according to the present embodiment. FIG. 3 is a schematic cross-sectional view of the power storage cell according to the present embodiment. The power storage cell 1 includes a cell case 200, a wound electrode assembly 100, and an electrolyte solution (not shown).

### 2. Cell Case

The cell case 200 houses the wound electrode assembly 100 and the electrolyte solution. The cell case 200 is sealed. The cell case 200 may be made of metal, for example. The cell case 200 may include, for example, Al or the like. The cell case 200 may include, for example, a case main body 210 and a lid 220.

The case main body 210 includes a bottom wall 212 and a peripheral wall 214 (see FIG. 3). That is, the cell case 200 includes a bottom wall 212 and a peripheral wall 214. The bottom wall 212 may have, for example, a flat plate shape. In plan view, the bottom wall 212 may be rectangular. The “plan view” indicates that the object is viewed with a line of sight parallel to the thickness direction of the object. That is, a plan view of the bottom wall 212 indicates that the bottom wall 212 is viewed from the Z-axis direction. The peripheral wall 214 rises from the bottom wall 212. The peripheral wall 214 may be, for example, a quadrangular tube. The peripheral wall 214 connects the top wall 222 and the bottom wall 212.

The dimension of the peripheral wall 214 in the width direction (X-axis direction) of the case main body 210 may be larger than the dimension of the peripheral wall 214 in the thickness direction (Y-axis direction) of the case main body 210, for example. The dimension of the peripheral wall 214 in the height direction (Z-axis direction) of the case main body 210 may be larger than, for example, the dimension of the peripheral wall 214 in the thickness direction. The case main body 210 has an opening surface 211 (see FIG. 2). The opening surface 211 faces the bottom wall 212. The opening surface 211 is surrounded by the peripheral wall 214.

The lid 220 includes a top wall 222. That is, the cell case 200 includes a top wall 222. The lid 220 closes the opening surface 211. For example, the top wall 222 may be bonded to the peripheral wall 214 by laser welding. The top wall 222 may have, for example, a flat plate shape. The top wall 222 faces the bottom wall 212. For example, the pressure release valve 222a, the liquid injection hole 222b, the sealing member 222c, the through hole 222d, and the like may be provided in the top wall 222.

The height direction (Z-axis direction) of the power storage cell 1 is a direction from the bottom wall 212 toward the top wall 222. The height direction may be along the vertical direction. The height direction may be parallel to the vertical direction. The power storage cell 1 is of a longitudinal type. In the longitudinal type, the winding axis direction of the wound electrode assembly 100 is along the height direction. The angle (acute angle) formed between the winding axis direction and the height direction may be, for example, 30 degrees or less, 20 degrees or less, 10 degrees or less, or 5 degrees or less. The winding axis direction may be parallel to the height direction.

### 3. Wound Electrode Assembly

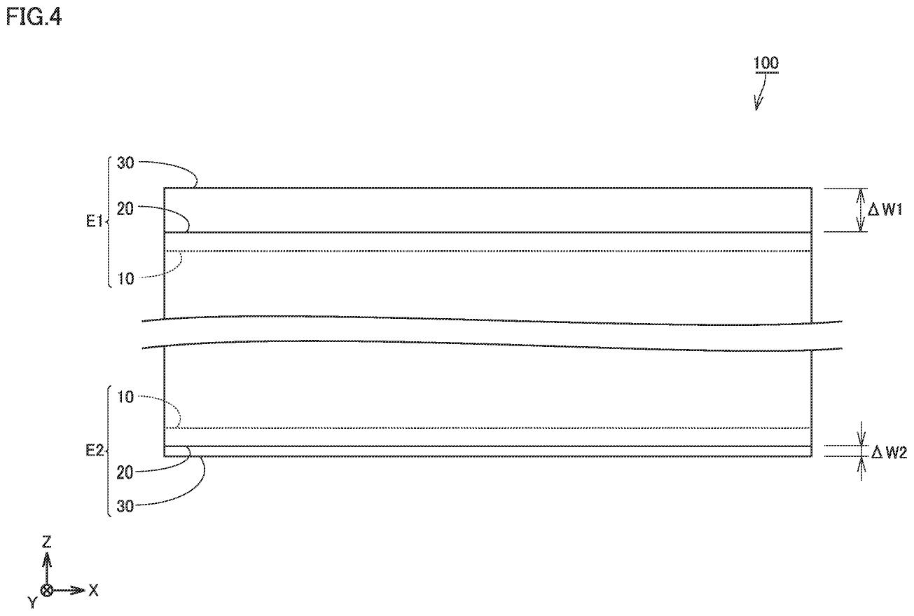

FIG. 4 is a conceptual diagram showing a stacking structure of a wound electrode assembly. The wound electrode assembly 100 includes a positive electrode sheet 10, a separator sheet 30, and a negative electrode sheet 20. The positive electrode sheet 10, the separator sheet 30, and the negative electrode sheet 20 are stacked in this order to form a stack. The stacking direction corresponds to the Y-axis direction in FIG. 4. That is, in the normal direction (Y-axis direction) of FIG. 4, the positive electrode sheet 10 is positioned at the farthest side. The negative electrode sheet 20 is positioned closest to the front side. The separator sheet 30 is interposed between the positive electrode sheet 10 and the negative electrode sheet 20. The stack is spirally wound to form the wound electrode assembly 100. The winding axis direction corresponds to the Z axis direction in FIG. 4. The Z-axis direction also corresponds to the width direction of each sheet. The wound electrode assembly 100 may have a flat outer shape (see FIG. 2). For example, the cylindrical wound electrode assembly 100 may be formed into a flat shape by being crushed in the diameter direction.

The wound electrode assembly 100 may include two or more separator sheets 30. The wound electrode assembly 100 may include, for example, a first separator sheet, a positive electrode sheet 10, a second separator sheet, and a negative electrode sheet 20 in this order. The wound electrode assembly 100 may include, for example, a positive electrode sheet 10, a first separator sheet, a negative electrode sheet 20, and a second separator sheet in this order.

Each sheet has a strip-shaped planar shape. That is, each sheet has a length direction and a width direction. In FIG. 4, the length direction corresponds to the X-axis direction. The width direction corresponds to the Z-axis direction. Further, the width direction is along the winding axis direction. In the winding axis direction (Z-axis direction), the wound electrode assembly 100 has a first end portion E1 and a second end portion E2. In the winding axis direction, the second end portion E2 is located on the opposite side of the first end portion E1. The first end portion E1 faces the top wall 222. The second end portion E2 faces the bottom wall 212. At both the first end portion E1 and the second end portion E2, the separator sheet 30 extends outward with respect to the negative electrode sheet 20. At the first end portion E1, the separator sheet 30 has a first protruding length ΔW1. The first protruding length ΔW1 can be referred to as a distance between the tip of the separator sheet 30 and the tip of the negative electrode sheet 20 in the winding axis direction (width direction). At the second end portion E2, the separator sheet 30 has a second protruding length ΔW2. The second protruding length ΔW2 may be referred to as a distance between the tip of the separator sheet 30 and the tip of the negative electrode sheet 20 in the width direction.

The first protruding length ΔW1 is larger than the second protruding length ΔW2. Thereby, the protruding portion of the separator sheet 30 on the first end portion E1 side can function as a weir of the electrolyte solution. Thus, overflow of the electrolyte solution from the first end portion E1 side can be reduced. For example, a dam of electrolyte solution may be formed at the first end portion E1.

When the wound electrode assembly 100 includes two separator sheets 30, at least one of the first separator sheet and the second separator sheet satisfies the relationship of “ΔW2<ΔW1”. For example, both the first separator sheet and the second separator sheet may satisfy the relationship of “ΔW2<ΔW1”. For example, the first separator sheet may satisfy the relationship of “ΔW2<ΔW1”, and the second separator sheet may satisfy the relationship of “ΔW2=ΔW1”.

The ratio (ΔW1/ΔW2) of the first protruding length ΔW1 to the second protruding length ΔW2 may be, for example, 1.5 to 5. The ratio (ΔW1/ΔW2) may be, for example, 2 to 3.

The difference (ΔW1−ΔW2) between the first protruding length ΔW1 and the second protruding length ΔW2 may be, for example, 1 to 5 mm. The difference (ΔW1−ΔW2) may be, for example, 2 to 3 mm. The first protruding length ΔW1 may be, for example, 2 to 5 mm. The first protruding length ΔW1 may be, for example, 2 to 4 mm. The second protruding length ΔW2 may be, for example, 0.5 to 1.5 mm. The second protruding length ΔW2 may be, for example, 0.5 to 1 mm.

The positive electrode sheet 10 is disposed so as not to protrude from the negative electrode sheet 20 in the width direction. The distance between the tip of the positive electrode sheet 10 and the tip of the negative electrode sheet 20 in the width direction may be 0.5 to 2 mm, for example. The positive electrode sheet 10 may 10 may include, for example, a metal foil and a positive electrode composite material layer. The metal foil may contain, for example, Al or the like. The metal foil may have a thickness of, for example, 5 to 50 μm. The positive electrode composite material layer may be disposed only on one side of the metal foil. The positive electrode composite material layer may be disposed on both surfaces of the metal foil. The positive electrode composite material layer includes a positive electrode active material. The positive electrode active material may contain, for example, a Li metal composite oxide. The positive electrode composite material layer may have a thickness of, for example, 10 to 1000 μm. For example, the positive electrode composite material layer may be formed by coating the surface of the metal foil with the positive electrode slurry. A non-coated portion may be formed on the upper long side of the metal foil. No positive electrode composite material layer was formed in the non-coated portion. In the non-coated portion, the metal foil is exposed. For example, a plurality of positive electrode tabs 110P may be bonded to the non-coated portion. The plurality of positive electrode tabs 110P may be spaced apart from each other.

The negative electrode sheet 20 may include, for example, a metal foil and a negative electrode composite material layer. The metal foil may contain, for example, Cu or the like. The metal foil may have a thickness of, for example, 5 to 50 μm. The negative electrode composite material layer may be disposed only on one side of the metal foil. The negative electrode composite material layer may be disposed on both surfaces of the metal foil. The negative electrode composite material layer includes a negative electrode active material. The negative electrode active material may contain, for example, graphite, Si, SiO, or the like. For example, the volume change (expansion and shrinkage) of the negative electrode composite material layer due to charge and discharge may promote overflow of the electrolyte solution from the wound electrode assembly 100. The negative electrode composite material layer may have a thickness of, for example, 10 to 1000 μm. For example, the negative electrode composite material layer may be formed by coating the surface of the metal foil with the negative electrode slurry. A non-coated portion may be formed on the upper long side of the metal foil. No negative electrode composite material layer was formed in the non-coated portion. In the non-coated portion, the metal foil is exposed. For example, a plurality of negative electrode tabs 110N may be bonded to the non-coated portion. The plurality of negative electrode tabs 110N may be spaced apart from each other.

The separator sheet 30 may have a thickness of, for example, 5 to 50 μm. The separator sheet 30 has an insulating property. The separator sheet 30 may include, for example, polyethylene (PE), polypropylene (PP), or the like. The separator sheet 30 may have a single-layer structure. The separator sheet 30 may comprise, for example, a PE layer. The separator sheet 30 may have a multilayer structure. The separator sheet 30 may include, for example, a PP layer, a PE layer, and a PP layer in this order. The surface of the separator sheet 30 may be coated with inorganic particles.

The separator sheet 30 is porous. The separator sheet 30 may have an average pore size of, for example, 0.01 to 1 μm. “Average pore size” can be measured by mercury indentation. The separator sheet 30 may have, for example, a Gurley value of 50 to 250 s/100 cm³. “Gurley value” may be measured by a Gurley test method.

### 4. Electrolyte Solution

The electrolyte solution is a liquid electrolyte. The electrolyte solution may contain, for example, a Li salt and an organic solvent. The wound electrode assembly 100 is impregnated with the electrolyte solution. The entire electrolyte solution may be impregnated in the wound electrode assembly 100. A part of the electrolyte solution may exist outside the wound electrode assembly 100. The electrolyte solution present outside the wound electrode assembly 100 may also be referred to as an “excess liquid”. The electrolyte solution overflowing from the wound electrode assembly 100 may become an excess solution. For example, excess liquid may be stored between the wound electrode assembly 100 and the insulating film 120. For example, excess liquid may be stored in the bottom wall 212 of the case main body 210. At the second end portion E2, the tip of the separator sheet 30 may be immersed in the excess liquid.

### 5. Other Configurations

The coupling member 400 is electrically conductive (see FIG. 3). The coupling member 400 includes a current collector plate 410. The current collector plate 410 is connected to a plurality of tabs. The current collector plate 410 includes a positive electrode current collector plate 410P and a negative electrode current collector plate 410N. The positive electrode current collector plate 410P connects a plurality of positive electrode tabs 110P and positive electrode coupling pins 420P. For example, at least one of the positive electrode current collector plate 410P and the negative electrode current collector plate 410N may include a fuse portion. The fuse portion may interrupt the circuit when an overcurrent flows. For example, the fuse portion may be melted by Joule heat.

The positive electrode terminal 300P includes a positive electrode terminal plate 310, a positive electrode terminal block 320, and a positive electrode coupling pin 420P (see FIG. 3). The positive electrode terminal plate 310 may have, for example, a rectangular parallelepiped outer shape. The positive electrode terminal plate 310 may be made of metal, for example. The positive electrode terminal plate 310 may contain, for example, Al or the like. The positive electrode terminal block 320 may be made of metal, for example. The positive electrode terminal block 320 may have a material different from that of the positive electrode terminal plate 310, for example. The positive electrode terminal block 320 may have a lower melting point than the positive electrode terminal plate 310. The positive electrode terminal block 320 may contain, for example, Fe or the like. The positive electrode terminal block 320 is bonded to the upper surface of the top wall 222. A positive electrode terminal plate 310 is bonded to the upper surface of the positive electrode terminal block 320.

The positive electrode coupling pin 420P may have, for example, a cylindrical outer shape. Through holes are formed in each of the positive electrode terminal plate 310 and the positive electrode terminal block 320. The positive electrode coupling pin 420P is inserted through the through hole. Further, the positive electrode coupling pin 420P is inserted into the coupling hole 412h. The upper end portion of the positive electrode coupling pin 420P may be fixed to the positive electrode terminal plate 310 by caulking, for example.

The negative electrode terminal 300N includes a negative electrode terminal plate 330 and a negative electrode coupling pin 420N (see FIG. 3). The negative electrode terminal plate 330 may be made of metal, for example. The negative electrode terminal plate 330 may contain, for example, Cu, Ni, or the like. The insulating member 340 electrically insulates the negative electrode terminal 300N from the top wall 222. The insulating member 340 may be made of, for example, a resin material. The inversion plate 224 may have, for example, a dish-shaped or bowl-shaped outer shape. When the internal pressure of the cell case 200 increases, the inversion plate 224 may be inverted. When the inversion plate 224 is inverted, the top wall 222 and the negative electrode terminal 300N may be electrically connected to each other.

The negative electrode current collector plate 410N connects a plurality of negative electrode tabs 110N and a negative electrode coupling pin 420N. That is, the coupling member 400 electrically connects the wound electrode assembly 100 and the negative electrode terminal 300N. The negative electrode coupling pin 420N connects the negative electrode current collector plate 410N and the negative electrode terminal plate 330. The negative electrode coupling pin 420N may have, for example, a cylindrical outer shape. The negative electrode coupling pin 420N is inserted into the coupling hole 412h. The upper end portion of the negative electrode coupling pin 420N may be fixed to the negative electrode terminal plate 330 by caulking, for example.

The insulator 500 insulates the coupling member 400 from the cell case 200. Insulator 500 includes an insulating sheet 510 and an insulating gasket 520. The insulating sheet 510 is connected to the lower surface of the top wall 222. In the height direction of the insulating sheet 510, a through hole is formed in a portion overlapping with the pressure release valve 222a, a portion overlapping with the liquid injection hole 222b, a portion overlapping with each through hole 222d, and a portion overlapping with the inversion plate 224.

The insulating gasket 520 has a shape surrounding the coupling pin 420. The insulating gasket 520 insulates the coupling pin 420 from the cell case 200. The insulating gasket 520 includes a positive electrode gasket 520P and a negative electrode gasket 520N. The positive electrode gasket 520P covers the positive electrode coupling pin 420P. The positive electrode gasket 520P has a cylindrical outer shape. The negative electrode gasket 520N covers the negative electrode coupling pin 420N. The negative electrode gasket 520N may have the same structure as the positive electrode gasket 520P. The negative electrode gasket 520N electrically insulates the top wall 222 from the negative electrode terminal 300N.

What is claimed is:

1. A power storage cell comprising:
a cell case;
a wound electrode assembly; and
an electrolyte solution, wherein
the cell case houses the wound electrode assembly and the electrolyte solution,
the wound electrode assembly is impregnated with the electrolyte solution,
the cell case includes a top wall, a peripheral wall, and a bottom wall,
the top wall faces the bottom wall,
the peripheral wall connects the top wall and the bottom wall,
the wound electrode assembly includes a positive electrode sheet, a separator sheet, and a negative electrode sheet,
a winding axis direction of the wound electrode assembly is along a direction from the bottom wall toward the top wall, and
in the winding axis direction,
the wound electrode assembly has a first end portion and a second end portion,
the first end portion faces the top wall,
the second end portion is located opposite to the first end portion,
at both the first end portion and the second end portion, the separator sheet extends outward with respect to the negative electrode sheet,
at the first end portion, the separator sheet has a first protruding length,
at the second end portion, the separator sheet has a second protruding length,
each of the first protruding length and the second protruding length is a length of the separator sheet protruding from the negative electrode sheet in the winding axis direction, and
the first protruding length is longer than the second protruding length.

2. The power storage cell according to claim 1, wherein a ratio of the first protruding length to the second protruding length is 1.5 to 5.

3. The power storage cell according to claim 1, wherein a difference between the first protruding length and the second protruding length is 1 to 5 mm.

4. The power storage cell according to claim 1, wherein
the first protruding length is 2 to 5 mm, and
the second protruding length is 0.5 to 1.5 mm.

5. The power storage cell according to claim 1, wherein
the cell case includes a case main body and a lid,
the case main body includes the peripheral wall and the bottom wall,
the peripheral wall rises from the bottom wall,
the case main body has an opening surface,
the opening surface faces the bottom wall,
the lid includes the top wall, and
the lid closes the opening surface.
